(19) United States
(12) Patent Application Publication
(10) Pub. No.: US 2009/0002753 A1
(43) Pub. Date: Jan. 1, 2009

(54) ANALYSIS METHOD, ANALYSIS SYSTEM, ANALYSIS APPARATUS AND RECORDING MEDIUM

(75) Inventors: Madoka MITSUOKA, Kawasaki (JP); Yasuhide Matsumoto, Kawasaki (JP); Masatomo Yasaki, Kawasaki (JP); Youji Kohda, Kawasaki (JP); Satoru Watanabe, Kawasaki (JP); Mitsuru Oda, Kawasaki (JP); Hiroki Ichiki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/133,867

(22) Filed: Jun. 5, 2008

(30) Foreign Application Priority Data
Jun. 20, 2007 (JP) 2007-163087

(51) Int. Cl. G06F 3/12

(52) U.S. Cl. 358/1.15

(57) ABSTRACT

An analysis system for analyzing the usage pattern of a machine operating in accordance with control information transmitted from an information processing apparatus by using an analysis apparatus. The system includes the information processing apparatus and the analysis apparatus. The information processing apparatus includes a first transmitting part transmitting control information for controlling the machine to the analysis apparatus. The analysis apparatus includes a receiving part receiving the control information transmitted from the information processing apparatus, an output part outputting the received control information to the machine, a calculating part calculating a load value of the processing on the machine based on the received control information, a storage part storing a total value of the calculated load values of the machine, into a storage section, and a second transmitting part transmitting warning information to the information processing apparatus if the stored total value reaches the reference value.

### CROSS-REFERENCE TO RELATED APPLICATIONS

This application is based upon and claims the benefit of priority from the prior Japanese Patent Application No. 2007-163087, filed on Jun. 20, 2007, the entire contents of which are incorporated herein by reference.

### BACKGROUND

1. Field

The invention relates to an analysis method, analysis system, analysis apparatus, which analyze the usage pattern of a machine operating according to the control information transmitted from an information processing apparatus by using the analysis apparatus having a control section, and a recording medium recording a program for causing the analysis apparatus to function.

2. Description of the Related Art

The service for a machine such as a copier, a printer, a large-capacity storage or a super computer, does not end when it is sold. Periodic maintenance and checks are required even after selling. For that reason, a maintenance contract is entered into upon selling between the manufacturer of the machine or a maintenance company and a user on condition that a predetermined fee is paid. In order to calculate the fee as properly as possible, a system has been conventionally proposed in which a different fee is calculated for each user in accordance with the output from a sensor provided on a copier. For example, refer to JP-A-2005-202045.

However, it is not appropriate to have a fixed fee that is independent of the usage pattern. The system disclosed in JP-A-2005-202045 requires feedback be provided by using a sensor attached to a subject machine, which disadvantageously complicates the configurations of the machine.

### SUMMARY

According to an aspect of the invention, an analysis method analyzes the usage pattern of a machine operating in accordance with control information transmitted from an information processing apparatus by using an analysis apparatus. The method includes receiving the control information transmitted from the information processing apparatus connected thereto over a communication network, calculating a load value of processing on the machine based on the received control information, storing the total value of load values of the machine, into a storage section by the control section; and transmitting warning information to the information processing apparatus if the stored total value reaches a reference value stored in the storage section.

According to another aspect of the invention, an analysis system analyzes the usage pattern of a machine operating in accordance with control information transmitted from an information processing apparatus by using an analysis apparatus. The system includes the information processing apparatus and the analysis apparatus. The information processing apparatus further includes a first transmitting part transmitting control information for controlling the machine to the analysis apparatus. The analysis apparatus further includes a receiving part receiving the control information transmitted from the information processing apparatus, an output part outputting the control information received by the receiving part to the machine, a calculating part calculating a load value of the processing on the machine based on the control information received by the receiving part, a storage part storing a total value of the load values of the machine, which are calculated by the calculating part, into a storage section, and a second transmitting part transmitting warning information to the information processing apparatus if the total value stored by the storage part reaches the reference value stored in the storage section.

According to another aspect of the invention, an analysis apparatus analyzes the usage pattern of a machine operating in accordance with control information transmitted from an information processing apparatus. The analysis apparatus includes a receiving part receiving the control information transmitted from an information processing apparatus connected thereto over a communication network, an output part outputting the control information received by the receiving part to the machine, a calculating part calculating a load value of the processing on the machine based on the control information received by the receiving part, a storage part storing a total value of the load values of the machine, which are calculated by the calculating part, into a storage section, and a transmitting part transmitting warning information to the information processing apparatus if the total value stored by the storage part reaches the reference value stored in the storage section.

According to another aspect of the invention, a computer-readable storage medium stores a program for analyzing the usage pattern of a machine operating in accordance with control information transmitted from an information processing apparatus by using an analysis apparatus having a control section. The program causes a computer to function with a receiving operation of receiving the control information transmitted from the information processing apparatus, a calculating operation of calculating a load value of processing on the machine based on the control information received by the receiving operation by the control section, a storing operation of storing the total value of load values of the machine, which are calculated by the calculating operation, into a storage section, and a transmitting operation of transmitting warning information to the information processing apparatus by the control section if the total value stored by the storing operation reaches a reference value stored in the storage section.

The above-described embodiments of the present invention are intended as examples, and all embodiments of the present invention are not limited to including the features described above.

### BRIEF DESCRIPTION OF THE DRAWINGS

FIG. 1 is a schematic diagram showing the configuration of an analysis system;

FIG. 2 is a block diagram showing the hardware configurations of a print server and a printer;

FIG. 3 is a block diagram showing the hardware configuration of a user's PC;

FIG. 4 is an explanatory diagram sowing a record layout of a history file;

FIG. 5 is an explanatory diagram showing a record layout of a job point file;

FIG. 6 is a graph showing a characteristic of a function f(tᵢ−t₀);

FIG. 7 is an explanatory diagram showing a record layout of a coefficient storage section;

FIG. 8 is a graph showing a characteristic of a function g(tᵢ−tᵢ₋₁);

FIG. 9 is an explanatory diagram showing a record layout of an auxiliary coefficient storage section;

FIG. 10 is a block diagram showing the hardware configuration of a manager's PC;

FIG. 11 is an explanatory diagram showing a record layout of an IP address storage section of the print server;

FIG. 12 is an explanatory diagram showing an image of warning information;

FIG. 13 is a block diagram showing the hardware configuration of a Web server;

FIG. 14 is an explanatory diagram showing a record layout of a contract file;

FIG. 15 is an explanatory diagram showing an image of a contract update screen;

FIG. 16 is a flowchart showing a routine up to the transmission of warning information;

FIG. 17 is a flowchart showing the routine up to the transmission of warning information;

FIG. 18 is a flowchart showing a routine of point calculating processing;

FIG. 19 is a flowchart showing a routine of contract update processing;

FIG. 20 is a flowchart showing the routine of the contract update processing;

FIG. 21 is a flowchart showing the routine of the contract update processing;

FIG. 22 is a schematic diagram showing the configuration of an analysis system according to a second embodiment;

FIG. 23 is a block diagram showing the hardware configurations of user's PC and a printer according to the second embodiment;

FIG. 24 is a flowchart showing a routine of printing processing according to the second embodiment;

FIG. 25 is a flowchart showing the routine of the printing processing according to the second embodiment;

FIG. 26 is a block diagram showing the configurations of a print server and a printer according to a third embodiment;

FIG. 27 is a schematic diagram showing the configuration of an analysis system according to a fourth embodiment;

FIG. 28 is a block diagram showing the hardware configuration of a DB server according to the fourth embodiment;

FIG. 29 is an explanatory diagram showing a record layout of a job point file according to the fourth embodiment;

FIG. 30 is a flowchart showing a routine of transmitting warning information according to the fourth embodiment; and

FIG. 31 is a flowchart showing the routine of transmitting warning information according to the fourth embodiment.

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

### First Embodiment

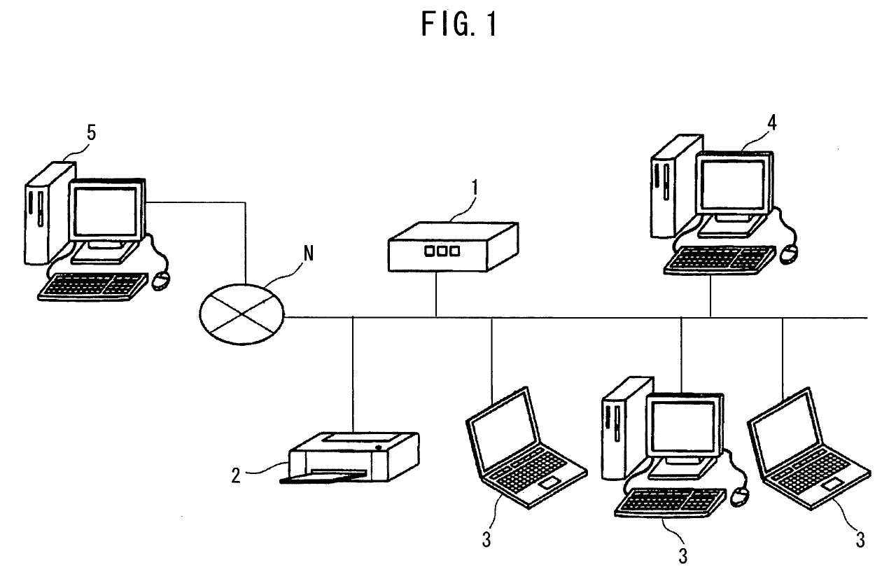

Embodiments of the invention will be described below with reference to the drawings. FIG. 1 is a schematic diagram showing the configuration of an analysis system. The analysis system includes a machine, an analysis apparatus, information processing apparatus, a communication network N and a server computer 5. Assuming that the machine and the analysis apparatus are a printer 2 and a print server 1, respectively, an example will be described in which the invention is applied to a system that analyses control information transmitted to the printer 2.

The printer 2, the print server 1, user's computers 3 (which will be called user's PC 3) each functioning as the information processing apparatus, a computer 4 of a manager (which will be called manager's PC 4) are connected mutually over a LAN (Local Area Network) within a company or a school. A user transmits control information for printing a document created in the user's PC 3 to the printer 2 through the print server 1. It is assumed in the following description that the control information is a job including job details describing either black-and-white/one-side printing or color/both side printing, for example, and the number of sheets to be printed.

The print server 1 receives the job transmitted from the user's PC 3 and transmits the received job to the printer 2. The printer 2 performs printing according to the transmitted job. The print server 1 analyzes the job transmitted from the user's PC 3 and calculates a load value (which will be called points hereinafter). By repetitively performing the job, the total value of the points increases.

The print server 1 transmits information on the guidance of the update to the user's PC 3 or manager's PC 4 in order to implement a contract update procedure if the total value reaches a pre-stored reference value (which will be called a reference point hereinafter). In the contract update procedure, the contract update is performed including the change in reference point between the user's PC 3 or manager's PC 4 and the server computer 5 (which will be called Web server 5) connecting thereto over the communication network N such as the Internet. An example in which the contract update is performed by using the manager's PC 4 will be described below.

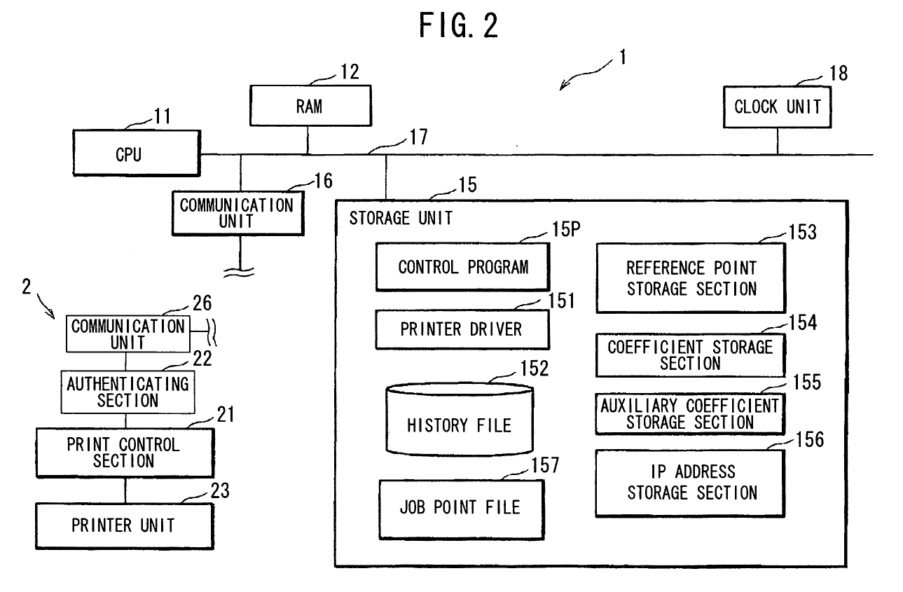

FIG. 2 is a block diagram showing the hardware configurations of the print server 1 and the printer 2. The print server 1 includes a CPU (Central Processing Unit) 11 functioning as a control section, a RAM (Random Access Memory) 12, a communication unit 16, a clock unit 18 and a storage unit 15. The CPU 11 connects to and controls hardware components of the print server 1 via a bus 17 and implements software functions according to a control program 15P stored in the storage unit 15.

The communication unit 16 is a wired or wireless LAN (Local Area Network) card, for example, and exchanges information such as a job under a protocol such as TCP/IP (Transmission Control Protocol/Internet Protocol). The storage unit 15 including a memory stores the control program 15P, a printer driver 151 for controlling the printer 2, a history file 152, a job point file 157, a reference point storage section 153, a coefficient storage section 154, an auxiliary coefficient storage section 155 and an IP address storage section 156, the details of which will be described later. The clock unit 18 outputs information on the current date and time to the CPU 11.

The printer 2 includes a communication unit 26, an authenticating section 22, a print control section 21 and a printer unit 23. The printer 2 may be a publicly known inkjet printer, and the communication unit 26 receives a job transmitted from the print server 1. The job is output to the print control section 21 including a microprocessor, for example. The print control section 21 controls the printer unit 23 including an ink head, an ink tank and a sheet feeding mechanism according to the output job. The printer unit 23 prints text or an image, for example, under the control of the print control section 21.

The authenticating section 22 stores an IP address or a MAC (Media Access Control) address of the print server 1 or the IP addresses of the user's PC 3 and manager's PC 4. The authenticating section 22 determines whether the address of the print server 1, user's PC 3 or manager's PC 4, which has output a job through the communication unit 26, agrees with one of the pre-stored addresses or not. If not, the authenticating section 22 cancels the job as an invalid job. If so on the other hand, the authenticating section 22 outputs the output job to the print control section 21 as a subject of the point calculation.

The authenticating section 22 determines whether the printing is to be permitted or not according to the instruction from the print server 1. If the total points as will be described later are higher than the reference points, the print server 1 transmits a signal of “printing not permitted”. In response thereto, the authenticating section 22 stops the transmission of information to the print control section 21. The authenticating section 22 further permits the transmission of information to the print control section 21 if the authenticating section 22 receives the signal of “authentication permitted” from the print server 1. Notably, having described that the printer 2 is an inkjet printer according to this embodiment, the printer 2 may be a multifunction machine further including a copying function and a facsimile function.

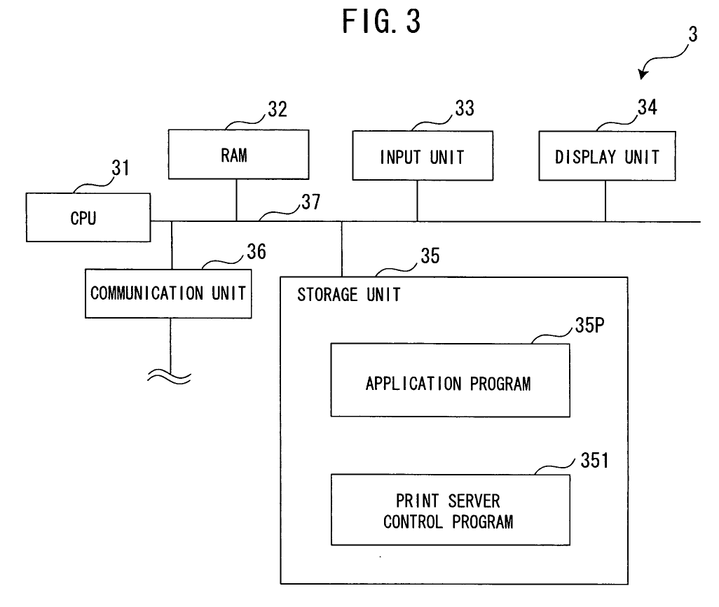

FIG. 3 is a block diagram showing the hardware configuration of the user's PC 3. The user's PC 3 includes a CPU 31 functioning as a control section, a RAM 32, an input unit 33, a display unit 34, a communication unit 36 and a storage unit 35. The CPU 31 connects to and controls the hardware components via a bus 37 and implements a software function according to a control program (not shown) stored in the storage unit 35.

The display unit 34 may be a liquid crystal display, for example. The input unit 33 may be a keyboard and a mouse, for example. The communication unit 36 may be a wired or wireless LAN (Local Area Network) card, for example. The communication unit 36 exchanges a job with the print server 1. The storage unit 35 may be a hard disk. The storage unit 35 stores an application program 35P such as Word (registered trademark) and PowerPoint (registered trademark) and a print server control program 351 for controlling the print server 1 and exchanging information with the print server 1.

A user may start the application program 35P through the input unit 33 and create a document or a slide. In the application program 35P, in a case where a user operates a print button through the input unit 33, the print server control program 351 starts, and the IP address of the user's PC 3 and the job are transmitted to the print server 1. The details of the job may be “black and white/one-side”, “color/one-side”, “black and white/both sides” or “color/both sides”, photograph printing, or other printing and an added stamp such as “CIRCULATION” or “URGENT”. For easy description, it is assumed that the job detail is one of “black and white/one-side”, “color/one-side”, “black and white/both sides” and “color/both sides”. It is also assumed that the amount of job is the number of sheets to be printed.

The print server 1 receives a job through the communication unit 16 and temporarily stores the received job in the RAM 12. The CPU 11 of the print server 1 loads the job stored in the RAM 12 and stores the job in the history file 152. As described above, the format of the job is converted to the format of the printer 2 by the printer driver 151, which is then transmitted to the communication unit 26 of the printer 2 through the communication unit 16.

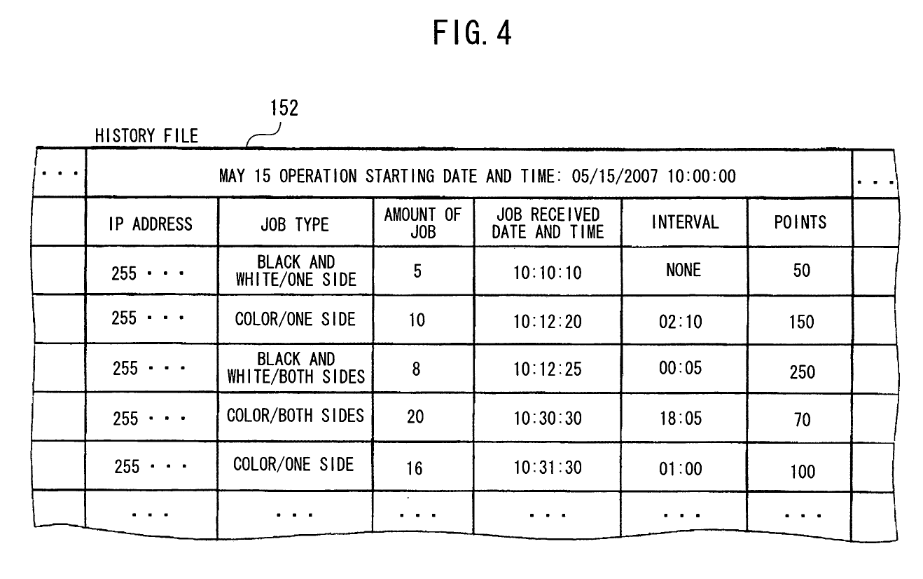

FIG. 4 is an explanatory diagram showing a record layout of the history file 152. The history file 152 sequentially stores jobs transmitted from the user's PC 3 for each day and also stores the calculated points. The history file 152 includes an IP address field, a job-detail field, an amount-of-job field, a job-received-date-and-time field, a time interval (which will be called interval) field and a point field. In the shown example, the history file 152 stores histories on May 15. The date and time when the printer 2 is powered on or is shifted from a standby state to an operating state is stored as the date and time when the operation starts. The CPU 11 receives the operation start signal from the printer 2 and stores the date and time upon receipt with reference to the clock unit 18. In this example, the history file 152 describes that the printer 2 started operating at 10:00 AM on May 15, 2007.

The IP address field stores the IP address of the user's PC 3, which has transmitted the job to the print server 1, and stores the job detail, the amount of job (that is, the number of sheets to be printed) and the job received date and time in relation with the IP address. For example, the job for black and white/one-side printing/5 sheets is stored at 10:10:10 as a history. The CPU 11 in response to the receipt of a job from the user's PC 3 stores the job detail and the amount of job in the history file 152 and stores the job received date and time to the history file 152 with reference to the date-and-time information output from the clock unit 18. Having described that the job received date and time is stored in the history file 152 according to this embodiment, the date and time when printing by the printer 2 ends may be stored. Alternatively, if a job is spooled, the date and time when the job is transmitted to the printer 2 may be stored in the history file 152. For easy description, this embodiment will be described based on the job received date and time.

The interval field stores an interval (time interval) from the date and time when one job is received and the printer 2 is operated to the date and time when subsequent another job is received and the printer 2 is operated. For example, the first job is received at 10:10:10, and the next job is received at 10:12:20. In this case, the interval is 2 minutes and 10 seconds.

Every time the CPU 11 receives a job, the CPU 11 obtains the difference between the date and time when the job is received immediately before and the date and time when the current job is received. The CPU 11 sequentially stores the obtained difference in the interval field. The point field stores points obtained for each job by the method as will be described later. As the value of the points increases, the load on the printer 2 increases.

The CPU 11 in response to the receipt of a job calculates the points in consideration of the job detail, the amount of job and the elapsed time from the date and time when the operation starts or the interval. An example will be described below in which the points are calculated by using all of the elements of the job detail, the amount of job, the elapsed time from the date and time when the operation starts and the interval, which may be properly used alone or in combination for calculation.

The CPU 11 loads a point calculation equation pre-stored in the storage section 15, calculates the points of each job according to the point calculation equation and stores the result in the history file 152. The point calculation equation is:

Points=Basic Point×Number Sheets to be Printed f(tᵢ−t₀)×g(tᵢ−tᵢ₋₁) (1).

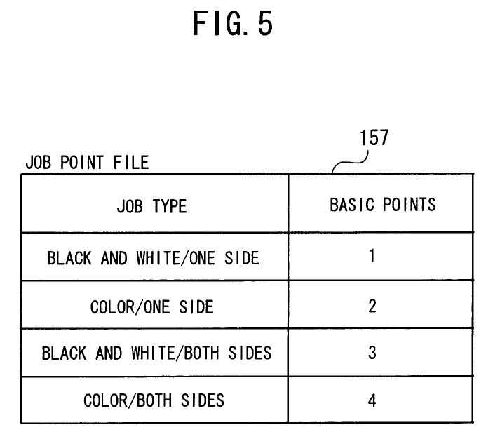

Here, the basic point is a point varying according to the job detail. FIG. 5 is an explanatory diagram showing a record layout of the job point file 157. The basic points are stored in relation with the job details. The basic point is a value increasing according to the magnitude of the load on the printer 2. For example, the basic point is 1 when the job detail is black and white/one-side. The basic point is 2 for the color/one-side. The basic point is 3 for black and white/both sides. The basic point is 4 for color/both sides.

The CPU 11 loads and stores the basic point from the job point file 157 to the RAM 12 with reference to the job detail of the job transmitted from the user's PC 3. The number of sheets to be printed corresponds to the amount of job. As the number of sheets increases, the number of points increases. The CPU 11 stores the amount of job of the job transmitted from the user's PC 3 to the RAM 12 as the number of sheets.

The function f(tᵢ−t₀) is a function having a coefficient decreasing as the time passes by. Here, it is the date and time when the ith job is received, t₀ is the date and time when the operation starts, and tᵢ−t₀ is an elapsed time from the start to the receipt of the job.

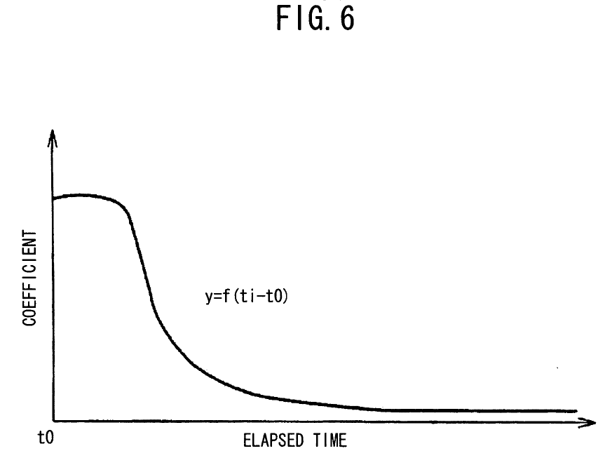

FIG. 6 is a graph showing a characteristic of the function f(tᵢ−t₀). The horizontal axis indicates the elapsed time, and the vertical axis indicates the coefficient. FIG. 6 shows changes in coefficient according to the changes in elapsed time, and the load is increased by warming up initially upon start of the printer 2, and a large value is defined for the coefficient. The coefficient largely decreases as the elapsed time increases and keeps a substantially constant value after a certain period of time.

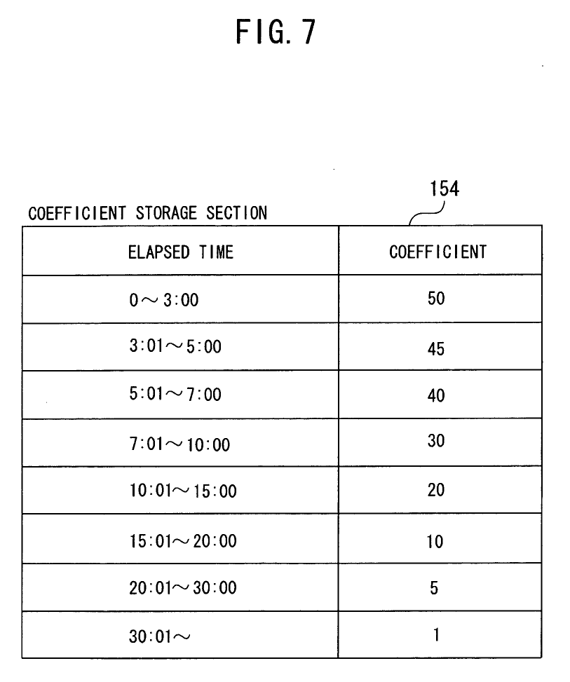

FIG. 7 is an explanatory diagram showing a record layout of the coefficient storage section 154. The coefficient storage section 154 stores a coefficient in relation with the elapsed time, simplifying the function f(tᵢ−t₀) shown in FIG. 6. As the elapsed time increases, the coefficient decreases. The CPU 11 obtains the difference between the job received date and time and the operation starting date and time, loads the coefficient corresponding to the elapsed time, which is the difference, from the coefficient storage section 154 and stores it to the RAM 12.

The function g(tᵢ−tᵢ₋₁) has a coefficient decreasing as the time passes by and then increasing again. Here, ti is the date and time when the ith job is received, tᵢ₋₁ is the date and time when the i−1th job is received, and tᵢ−tᵢ₋₁ is the interval between the dates and times when the jobs are received.

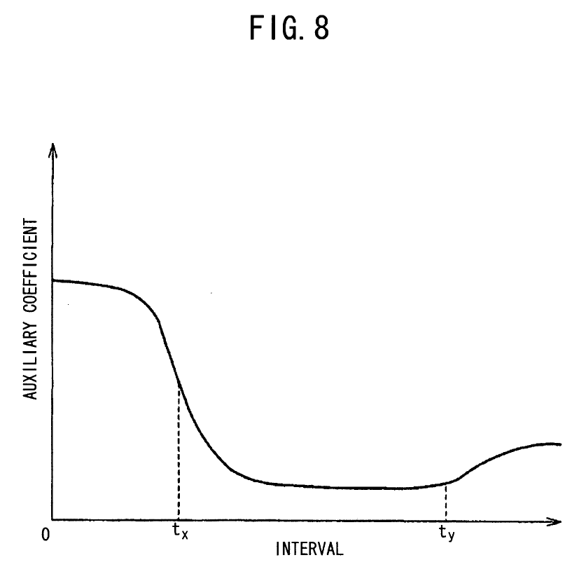

FIG. 8 is a graph showing a characteristic of the function g(tᵢ−tᵢ₋₁). The horizontal axis indicates intervals, and the vertical axis indicates auxiliary coefficients. FIG. 8 shows changes in auxiliary coefficient according to the changes in interval. In a case where the interval is extremely short, that is, when the interval is equal to or higher than 0 and equal to and lower than tₓ, the continuous operation increases the load on the printer 2. Therefore, a large auxiliary coefficient is defined. If the interval belongs to a predetermined period, that is, if the interval is larger than tₓ and is equal to or lower than t_{y}, it means an optimum operation condition. Therefore, a small auxiliary coefficient is defined.

If the interval is larger than t_{y}, the printer 2 shifts to a power saving mode and must be shifted to a normal operation mode again. Therefore, a large auxiliary coefficient is defined again. More specifically, the auxiliary coefficient decreases in order from the case where the interval is equal to or larger than 0 and equal to or smaller than tₓ, the case where the interval is larger than t_{y} and the case where the interval is larger than tₓ and equal to or smaller than t_{y}.

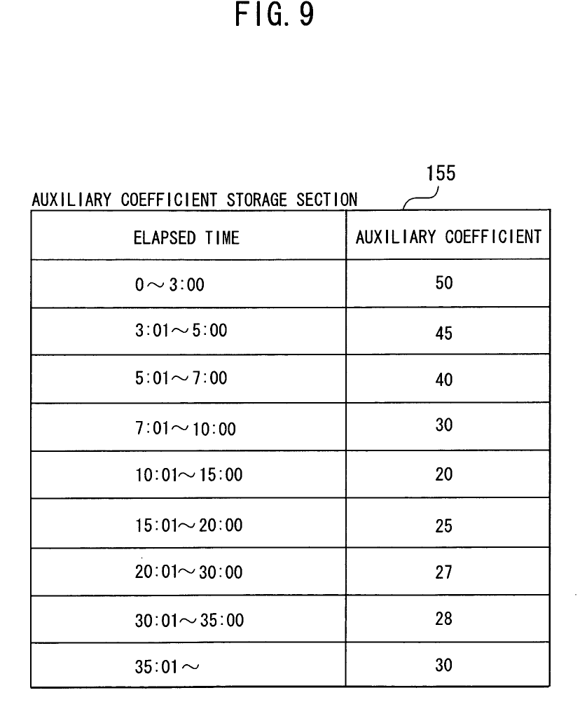

FIG. 9 is an explanatory diagram showing a record layout of the auxiliary coefficient storage section 155. The auxiliary coefficient storage section 155 stores an auxiliary coefficient in relation with an interval, simplifying the function g(tᵢ−tᵢ₋₁) shown in FIG. 8. As the interval increases, the auxiliary coefficient decreases once. As the interval further increases, the auxiliary coefficient increases again.

The CPU 11 obtains the difference between the job received date and time and the previous job received date and time, loads the auxiliary coefficient corresponding to the interval, which is the difference, from the auxiliary coefficient storage section 155 and stores it to the RAM 12. The first job after the operation starts has an auxiliary coefficient 1 since no jobs exist therebefore.

The CPU 11 multiples the equation (1) loaded from the storage unit 15 by the basic point stored in the RAM 12, the number of sheets to be printed, the coefficient and the auxiliary coefficient and thus calculates the points. The CPU 11 stores the calculated points in relation with the job in the point field of the history file 152. The CPU 11 calculates the total points of the calculated points and determines whether the calculated total points have reached the reference points stored in the reference point storage section 153. The CPU 11 transmits warning information to the manager's PC 4 if it is determined that the total points have reached the reference points.

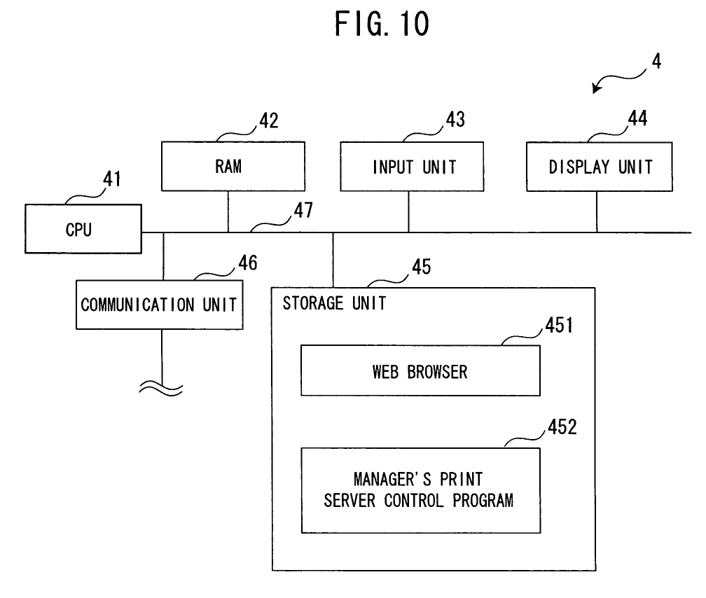

FIG. 10 is a block diagram showing the hardware configuration of the manager's PC 4. The manager's PC 4 includes a CPU 41 functioning as a control section, a RAM 42, an input unit 43, a display unit 44, a communication unit 46 and a storage unit 45. The CPU 41 connects to and controls the hardware components via a bus 47 and implements a software function according to a control program (not shown) stored in the storage unit 45. Since the manager's PC 4 is vertically the same as the user's PC 3, the detail descriptions will be omitted herein.

The storage unit 45 may be a hard disk, for example. The storage unit 45 stores a Web browser 451 such as Internet Explore (registered trademark) and a manager's print server control program 452. The communication unit 46 may be a LAN card, for example. The communication unit 46 exchanges information including an HTML (Hyper Text Markup Language) file with the Web server 5 by HTTP (Hyper Text Transfer Protocol).

The manager's print server control program 452 is a program for implementing setting such as security setting including changing the password of a manager of the print server 1, fixed assignment of an IP address and permission or rejection of a specific IP address, in addition to the function of the print server control program 351 installed in the user's PC 3. After starting the manager's print server control program 452, a manager may enter an ID and a password through the input unit 43 and performs setting for the print server 1.

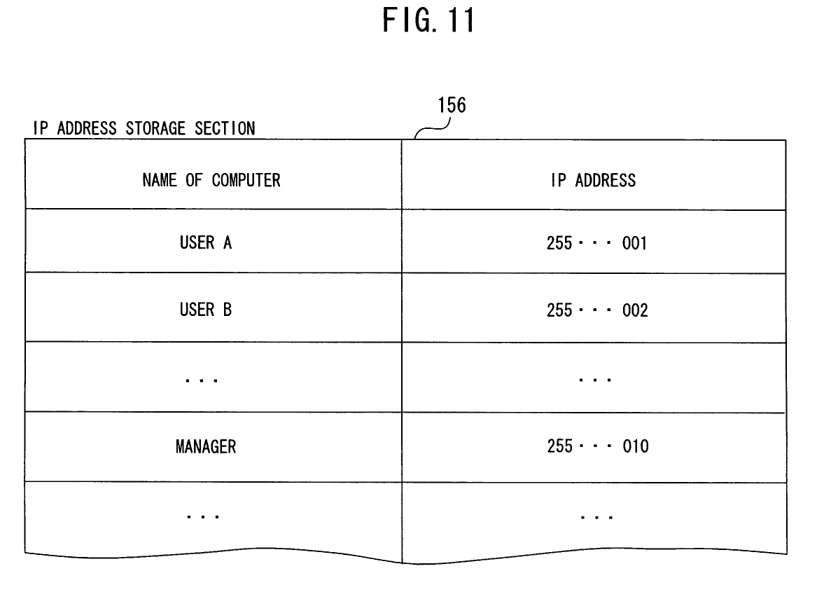

FIG. 11 is an explanatory diagram showing a record layout of an IP address storage section 156 of the print server 1. The IP address storage section 156 stores an IP address in relation with the name of a computer. The CPU 11 of the print server 1 transmits warning information to the manager's PC 4 if it is determined that the total points of the points stored in the history file 152 have reached reference points. The reference points have a value to be updated for each contract, and 1000 points, for example, may be stored upon the first contract.

The CPU 11 loads a message on the fact that the total points have reached the reference points pre-stored in the storage unit 15 and a message prompting contract update and creates a document in HTML containing a combination of the calculated total points and the reference points loaded from the reference point storage section 153. Furthermore, the CPU 11 loads a URL (Uniform Resource Locator), which is an address for accessing the Web server 5, describes it in the document and sets the hyperlink therefore. The CPU 11 transmits the thus created warning information to the manager's PC 4 stored in the IP address storage section 156. The CPU 11 may start a mailer and transmit the warning information to a pre-stored electronic mail address of the manager.

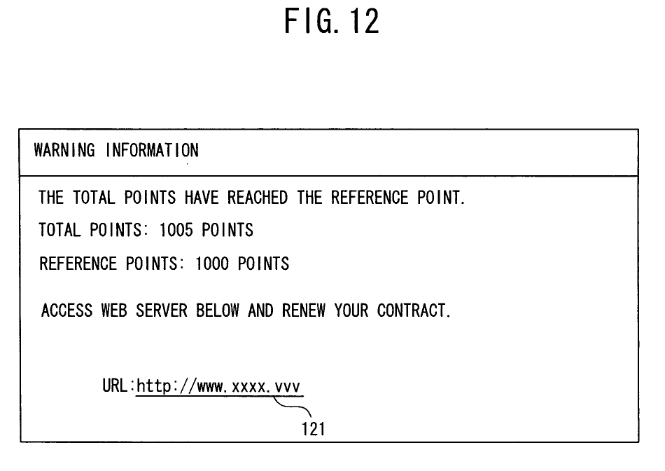

FIG. 12 is an explanatory diagram showing an image of the warning information. The communication unit 46 of the manager's PC 4 receives the warning information. The CPU 41 of the manager's PC 4 pop-up-displays the warning information on the display unit 44. As shown in FIG. 12, the message on the fact that the total points have reached the reference points and the total points and the reference points are displayed. In addition, a message for prompting access to the Web server 5 to update the contract and the URL for accessing the Web server 5 along with a hyperlink 121 are also displayed. When a manager clicks the hyperlink 121 through the input unit 43, the Web browser 451 starts, and the access to the Web server 5 is started. The hyperlink 121 contains codes indicating the total points and the reference points.

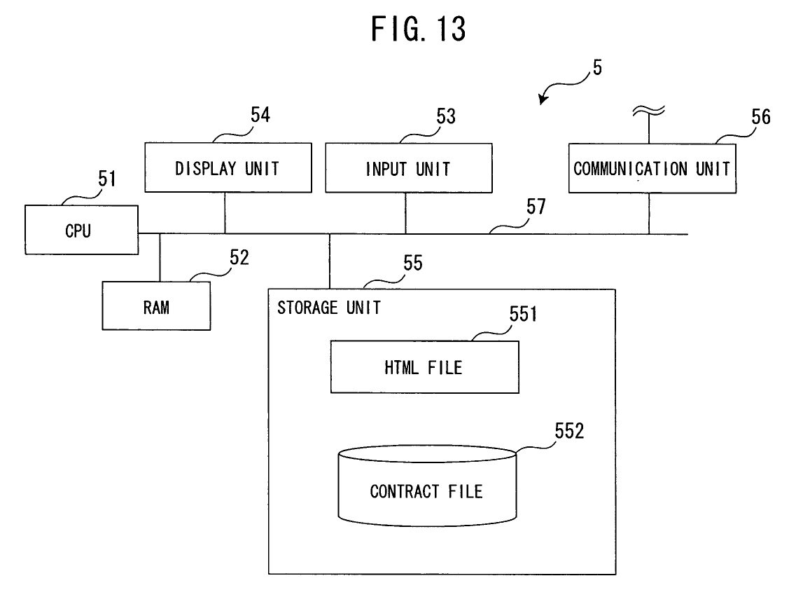

FIG. 13 is a block diagram showing the hardware configuration of the Web server 5. The Web server 5 includes a CPU 51 functioning as a control section, a RAM 52, a display unit 54, an input unit 53, a communication unit 56 and a storage unit 55. The CPU 51 connects to and controls the hardware components of the Web server 5 via a bus 57 and implements a software function according to a control program stored in the storage unit 55.

The communication unit 56 may be a gateway, for example, functioning as a firewall. The storage unit 55 stores an HTML file 551 and a contract file 552. The HTML file 551 hierarchically stores multiple Web pages in HTML. When the hyperlink 121 is clicked through the input unit 43 of the manager's PC 4, the IP address of the manager's PC 4 and the code indicating the current total points and the current reference points stored in the print server 1 are transmitted to the Web server 5. The CPU 51 of the Web sever 5 stores the current total points in the contract file 552 in relation with the IP address of the manager's PC 4.

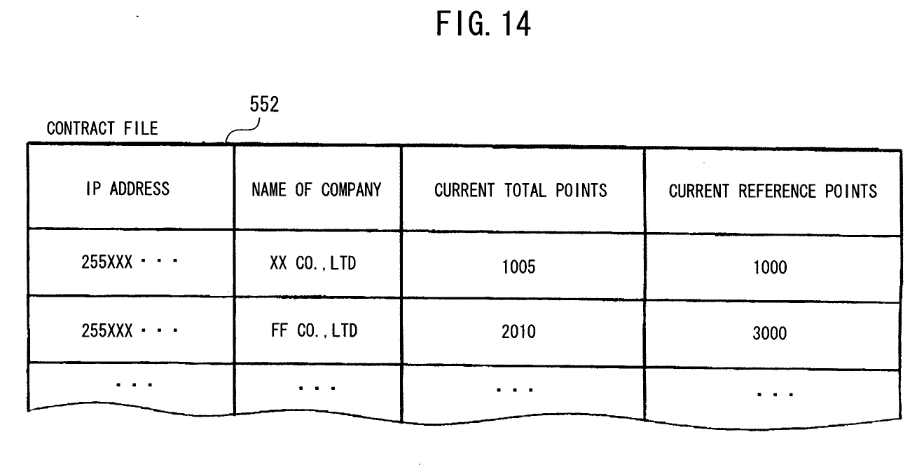

FIG. 14 is an explanatory diagram showing a record layout of the contract file 552. The contract file 552 stores the name of a company subject to a contract, the current total points and the current reference points in relation with an IP address. The CPU 51 stores the current total points transmitted by clicking the hyperlink 121 into the contract file 552 with reference to the IP address. For example, XX Co., Ltd. may have 1005 as the current total points, which is higher than the reference points 1000 upon the previous contract.

The CPU 51 of the Web server 5 loads a contract update screen from the HTML file 551, rewrites the name of a company, the current total points and the current reference points, which are stored in the contract file 552, and the updated reference points resulting from the addition of predetermined points to the current reference points into the loaded HTML file 551 and transmits them to the manager's PC 4. It is assumed here that the points to be added by the contract update are 1000.

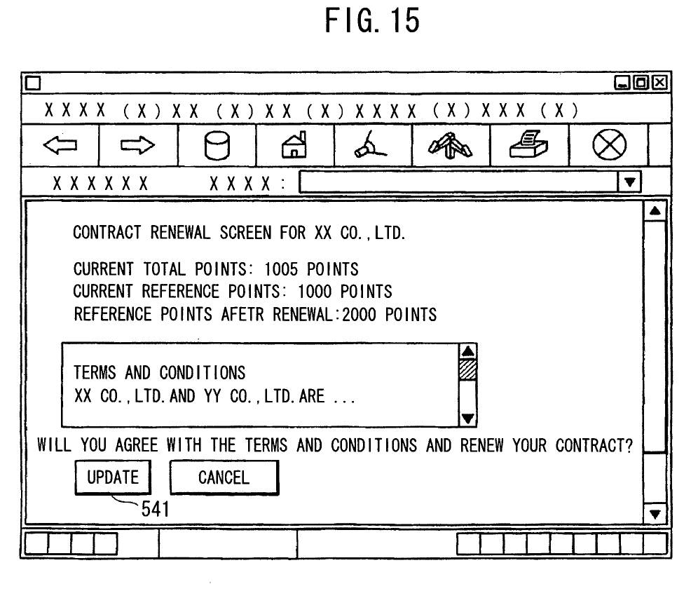

FIG. 15 is an explanatory diagram showing an image of the contract update screen. In response to the receipt of the contract update screen, the CPU 41 of the manager's PC 4 displays a contract update screen as shown in FIG. 15 on the Web browser 451. The contract update screen displays the name of a company, the current total points, the current reference points, the updated reference points and terms and conditions and a update button 541. A manager who desires the update may click the update button 541 through the input unit 43.

The CPU 41 receives the click on the update button 541 through the input unit 43 and transmits the information describing the update to the Web server 5. With reference to an IP address, the CPU 51 of the Web server 5 in response to the receipt of the information describing the update address adds 1000 to the current reference points of the contract file 552 and transmits the code indicating the update-permitted to the manager's PC 4. Then, payment processing for the contract update is performed.

The CPU 41 of the manager's PC 4 receives the code indicating the update-permitted from the Web server 5. The CPU 41 displays the code indicating the update-permitted to the Web browser 451. A manager accesses the print server 1 and inputs the code indicating the update-permitted on the setting screen through the input unit 43. The CPU 41 receives the code indicating the update-permitted input through the input unit 43 and transmits it to the print server 1. The CPU 11 of the print server 1 is triggered by the receipt of the code indicating the update-permitted to perform the processing of adding a pre-stored predetermined value, more specifically, 1000 to the reference points stored in the reference point storage section 153. Thus, the contract update procedure ends, and the printer 2 is available until the total points reach the reference points.

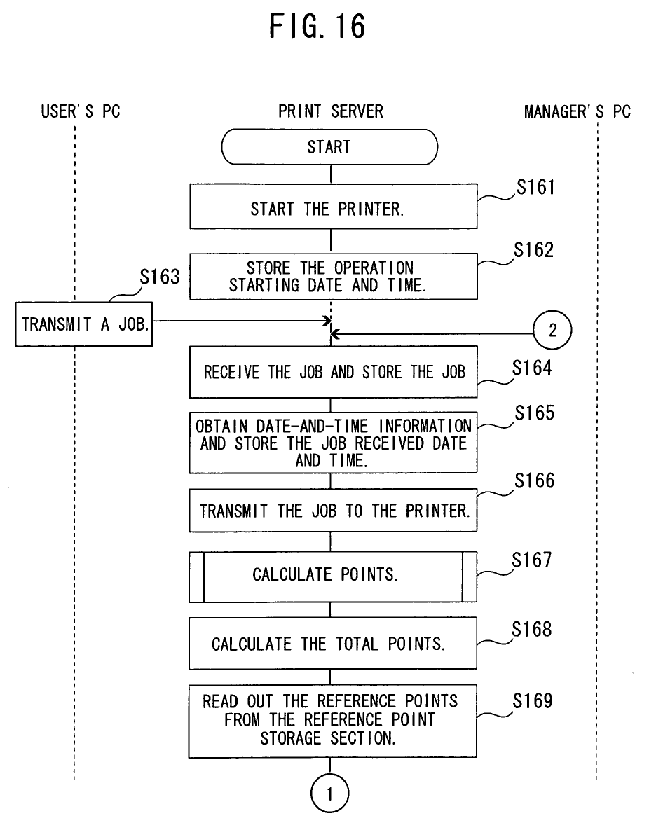

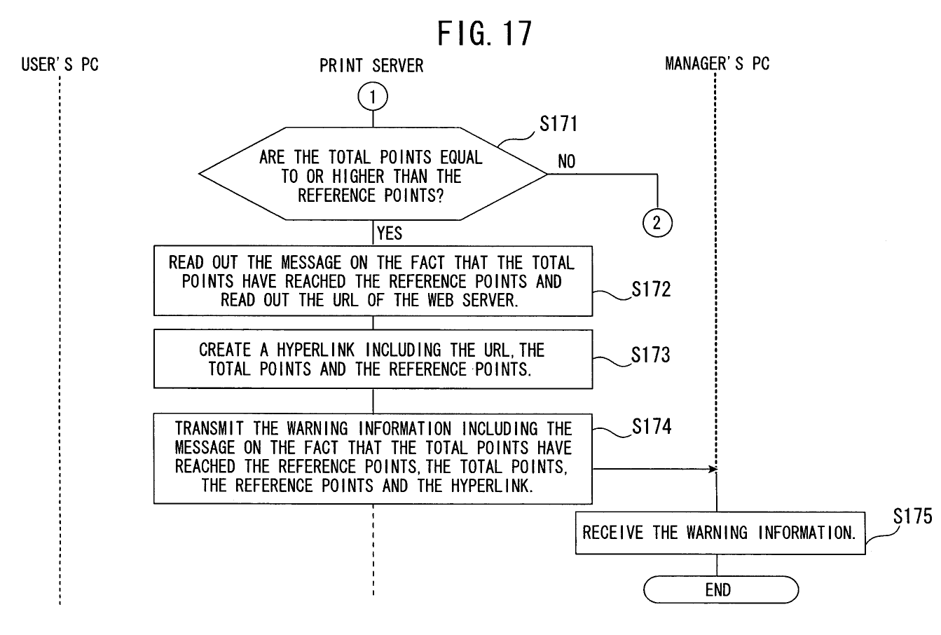

The routines of processing in the hardware configuration will be described with reference to flowcharts. FIGS. 16 and 17 are flowcharts showing a routine up to the transmission of warning information. A user may start the printer 2 (operation S161). The CPU 11 of the print server 1 in response to the receipt of an operation start signal from the printer 2 through the communication unit 16 refers to the output from the clock unit 18 and stores the operation starting date and time in the history file 152 (operation S162).

The CPU 31 of the user's PC 3 transmits a job to the print server 1 through the communication unit 36 (operation S163). The print server 1 receives the job transmitted through the communication unit 16 and stores the job in the history file 152 in relation with the IP address of the user's PC 3 (operation S164). The received job is output from the communication unit 16 to the CPU 11.

The CPU 11 obtains the date-and-time information from the clock unit 18 and stores the date-and-time information as the job received date and time in the history file 152 in relation with the IP address as shown in FIG. 4 (operation S165). The CPU 11 transmits the received job to the printer 2 under the control of the printer driver 151 (operation S166). The CPU 11 calculates points according to the control program 15P (operation S167). Subroutines of the calculation processing will be described later. The CPU 11 stores the calculated points in the history file 152 in relation with the job.

The CPU 11 calculates the total points of the points stored in the history file 152 (operation S168). The CPU 11 loads the reference points from the reference point storage section 153 (operation S169). The CPU 11 determines whether the total points calculated in operation S168 are equal to or higher than the reference points or not (operation S171). If it is determined that the total points are not equal to or higher than the reference points (NO in operation S171), the CPU 11 determines the availability within the current contract range and returns the processing to operation S164 again.

If it is determined that the total points are equal to or higher than the reference points (YES in operation S171) on the other hand, a message on the fact that the total points have reached the reference points and the URL of the Web server 5 are loaded from the storage unit 15 in order to prompt the contract update (operation S172). The CPU 11 creates the hyperlink 121 including the URL loaded in operation S172, the total points calculated in operation S168 and the reference points loaded in operation S169 (operation S173). More specifically, the CPU 11 encodes the total points and reference points under a predetermined rule. Then, the CPU 11 creates the hyperlink 121 having the encoded numerical values and an identifier (such as a membership number and an IP address) of a user using the printer 2 at the end of the URL loaded in operation S172.

The CPU 11 refers to the IP address storage section 156 and transmits warning information containing the message on the fact that the total points have reached the reference points loaded in operation S172, the total points and the reference points, which are loaded in operation S172, and the created hyper link 121 to the manager's PC 4 through the communication unit 16 (operation S174). The manager's PC 4 receives the warning information through the communication unit 46 (operation S175).

The warning information is output to the CPU 41, and the CPU 41 is triggered by the input of the warning information to display the warning information on the display unit 44 as shown in FIG. 12. If the CPU 11 of the print server 1 receives the job from the user's PC 3 after the total points have reached the reference points, the CPU 11 loads a message that printing service is not available because of the lack of points from the storage unit 15 and transmits the message to the user's PC 3 through the communication unit 16.

Alternatively, the CPU 11 may transmit a signal of print-non-permitting to the authenticating section 22 of the printer 2 through the communication unit 16. In this case, the authenticating section 22 receives the signal of print-non-permitting through the communication unit 26. The authenticating section 22 in response to the receipt of the signal of print-non-permitting stops the transmission of the job to be output to the print control section 21.

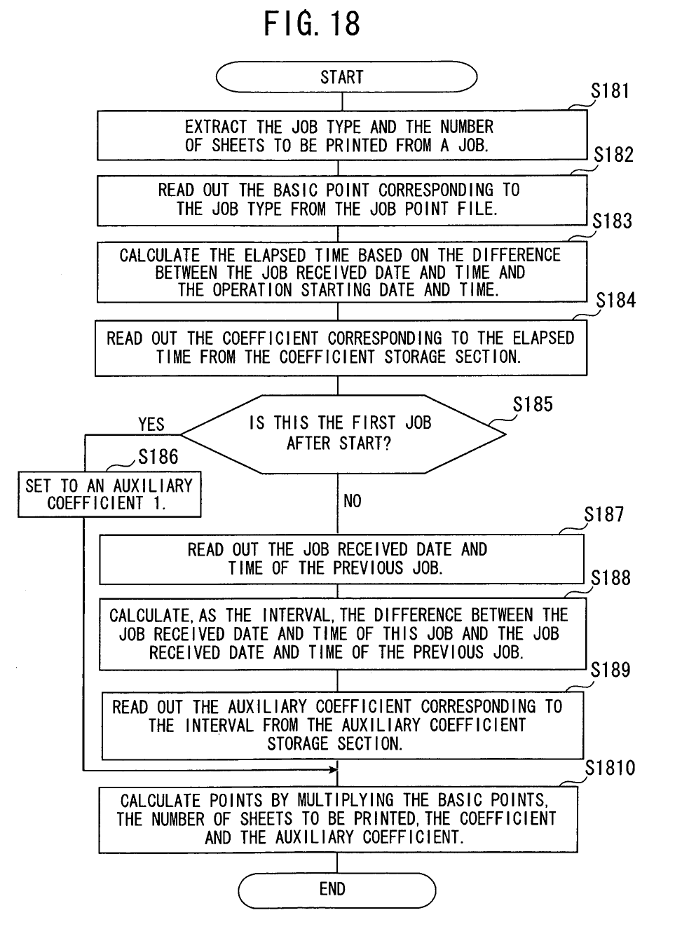

FIG. 18 is a flowchart showing a routine of the point calculating processing. The CPU 11 of the print server 1 extracts a job detail and the number of sheets to be printed based on the job transmitted from the user's PC 3 (operation S181). The CPU 11 loads the basic point corresponding to the job detail from the job point file 157 (operation S182). The CPU 11 calculates an elapsed time based on the difference between the job received date and time obtained in operation S165 and the operation starting date and time stored in operation S162 (operation S183).

The CPU 11 loads the coefficient corresponding to the calculated elapsed time from the coefficient storage section 154 (operation S184). The CPU 11 refers to the history file 152 and determines whether the received job is the first job after the start or not (operation S185). If not (NO in operation S185), the CPU 11 loads the job received date and time of the previous job from the history file 152 (operation S187). The CPU 11 calculates as an interval the difference between the job received date and time of the current job and the job received date and time of the previous job loaded in operation S187 (operation S188).

The CPU 11 loads the auxiliary coefficient corresponding to the interval from the auxiliary coefficient storage section 155 (operation S189). If it is determined that the job is the first job after the start in operation S185 (YES in operation S185), the CPU 11 sets 1 as the auxiliary coefficient (operation S186), and the processing in operations S187 to S189 is skipped since the calculation of the interval is not required. The CPU 11 calculates the points by multiplying the basic point loaded in operation S182 by the number of sheets to be printed, which is extracted in operation S181, the coefficient loaded in operation S184 and the auxiliary coefficient set in operation S186 or the auxiliary coefficient loaded in operation S189 (S1810). The CPU 11 stores the calculated points in the history file 152 of the storage unit 15 in relation with the job.

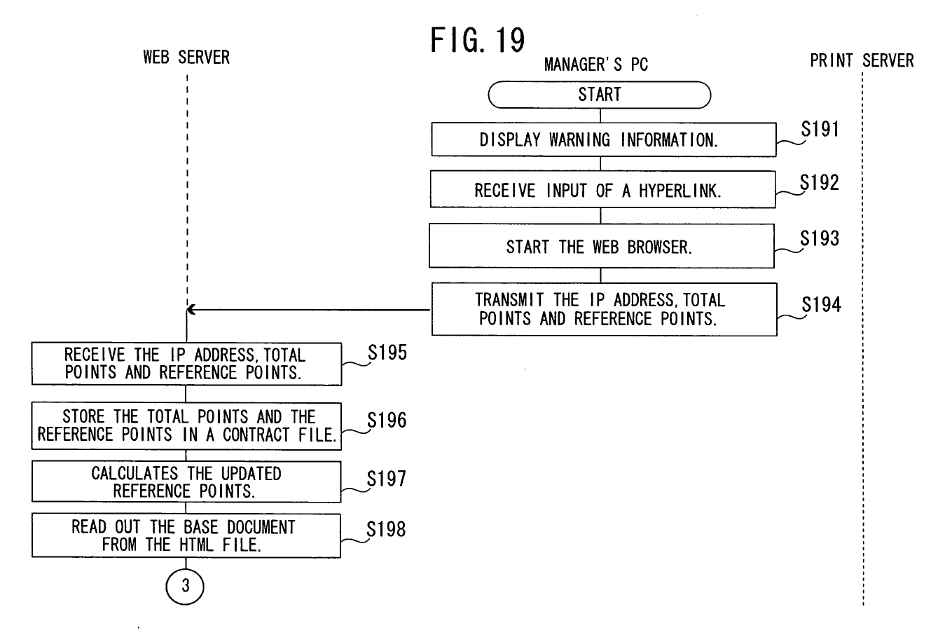

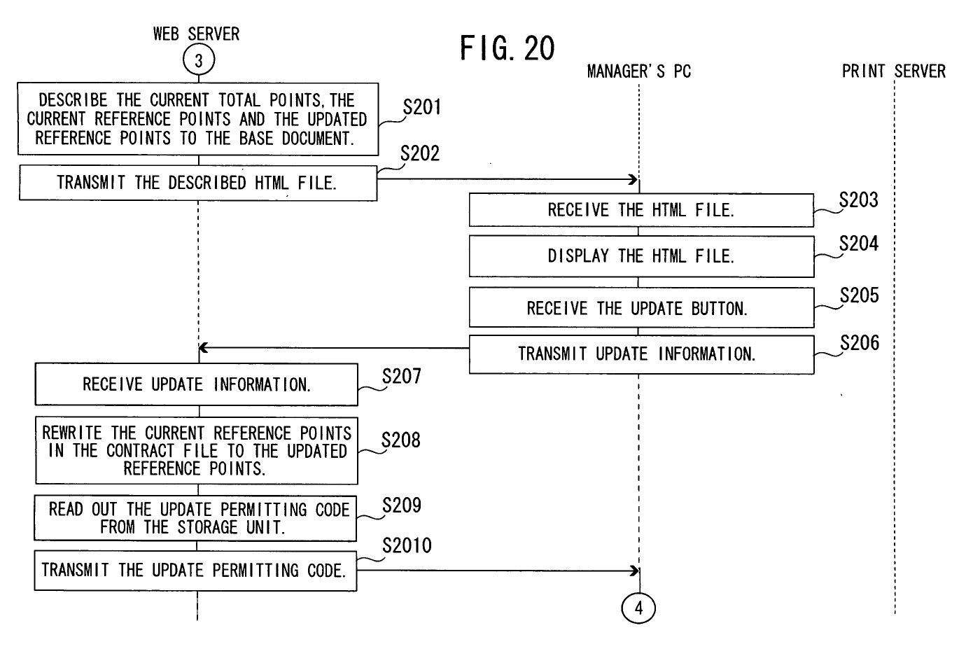

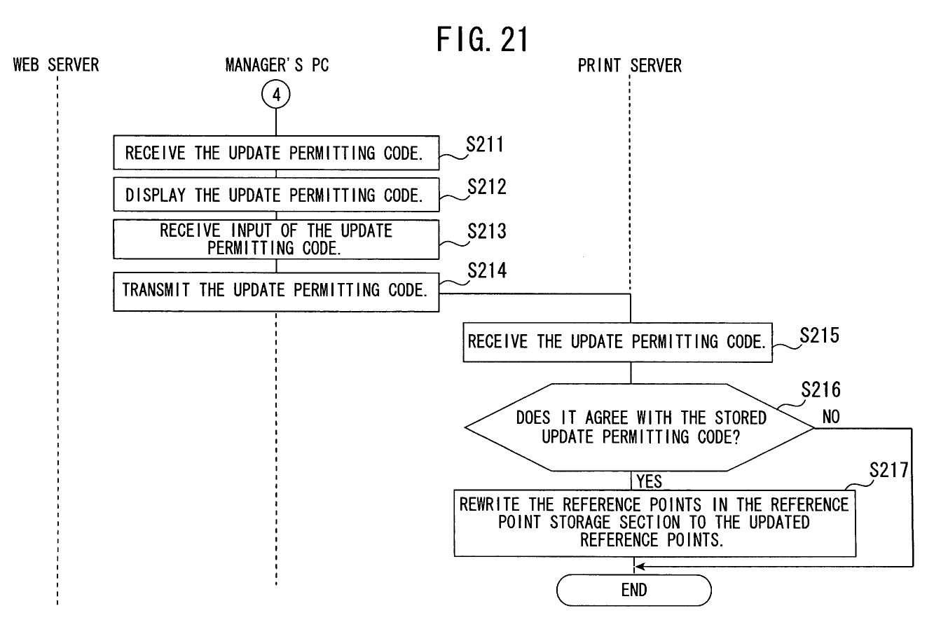

FIGS. 19 to 21 are flowcharts showing a routine of the contract update processing. The CPU 41 of the manager's PC 4 displays the warning information received in operation S175 on the display unit 44 (operation S191). The CPU 41 receives the input of the hyperlink 121 contained in the warning information through the input unit 43 (operation S192). The CPU 41 in response to the receipt of the input of the hyperlink 121 starts the Web browser 451 (operation S193). The CPU 41 transmits the IP address, total points and reference points to the Web server 5 (operation S194).

The CPU 51 of the Web server 5 receives the IP address, total points and reference points (operation S195). The CPU 51 refers to the received IP address and stores the received total points and reference points in the contract file 552 in relation with the IP address (operation S196). The CPU 51 calculates the updated reference points (operation S197). More specifically, predetermined points are added to the received reference points.

The CPU 51 loads the base document from the HTML file 551 (operation S198).

The CPU 51 describes the current total points, the current reference points and the updated reference points to the base document in the HTML file 551 loaded in operation S198 (S201). The CPU 51 transmits the described HTML file 551 to the manager's PC 4 (operation S202). The CPU 41 of the manager's PC 4 receives the transmitted HTML file 551 (operation S203) and displays it on the Web browser 451 as shown in FIG. 15 (operation S204).

The CPU 41 receives the input of the update button 541 through the input unit 43 (operation S205). The CPU 41 in response to the receipt of the update button 541 through the input unit 43 transmits the update information desiring the update to the Web server 5 (operation S206). The CPU 51 of the Web server 5 receives the update information (operation S207).

The CPU 51 rewrites the current reference points in the contract file 552 to the updated reference points (operation 208). For example, 1000 may be added to the current reference points, resulting in 2000 points as the updated reference points. The CPU 51 loads the update-permitted code stored in the storage unit 55 in advance (operation S209) and transmits the loaded update-permitted code to the manager's PC 4 (operation S2010).

The CPU 41 of the manager's PC 4 receives the update-permitted code (operation S211). The CPU 41 of the manager's PC 4 displays the update-permitted code on the display unit 44 (operation S212). The manager may enter and transmit an ID and a password of the manager in order to implement change of the setting in print server 1. The CPU 11 of the print server 1 transmits the screen for entering the update-permitted code to the manager's PC 4 if the transmitted ID and password agree with the pre-stored ID and password for the manager.

The display unit 44 of the manager's PC 4 displays an input receiving screen for a update-permitted code. A manager may enter the update-permitted code displayed in operation S212 through the input unit 43 of the manager's PC 4. The CPU 41 of the manager's PC 4 receives the update-permitted code, which is input through the input unit 43, (operation S213) and transmits the received update-permitted code to the print server 1 (operation S214). The CPU 11 of the print server 1 receives the update-permitted code (operation S215) and determines whether the received update-permitted code agrees with one of multiple update-permitted codes pre-stored in the storage unit 15 or not (operation S216). If not (NO in operation S216), the CPU 11 determines that it is invalid and exits the processing.

If so (YES in S216) on the other hand, the CPU 11 performs processing of rewriting the reference points in the reference point storage section 153 to the updated reference points (operation S217). Thus, the user's PC 3 then transmits the job to the print server 1. The CPU 11 of the print server 1 checks that the total points have not reached the updated reference points stored in the reference point storage section 153, performs calculation of the points again and transmits the job to the printer 2.

In a case where the signal of print-non-permitting is transmitted to the authenticating section 22 of the printer 2, the print server 1 outputs the signal of print-permitting to the authenticating section 22 through the communication unit 16 in order to cancel the transmitted signal of print-non-permitting. The authenticating section 22 permits the transmission of the job to the print control section 21 if the signal of print-permitting is received through the communication unit 26.

### Second Embodiment

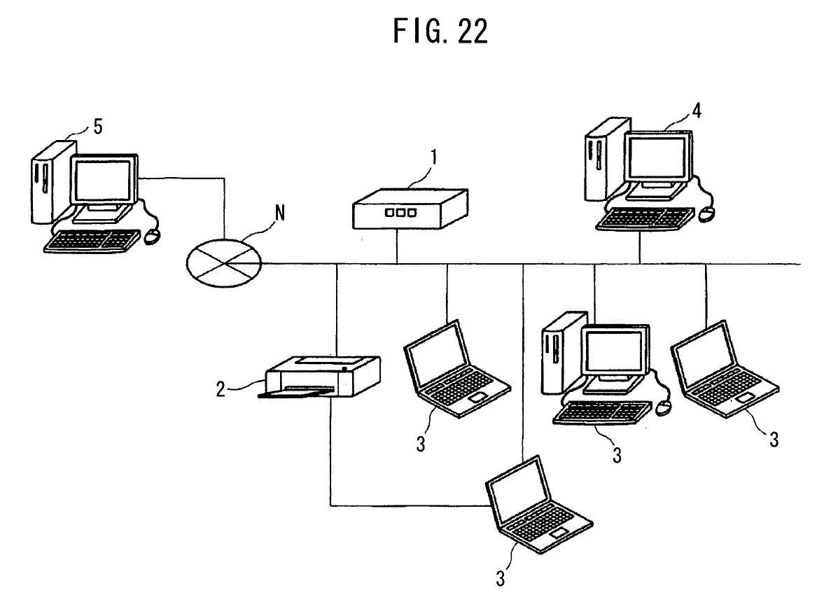

A second embodiment of the invention relates to a form of direct transmission of a job from the user's PC 3 to the printer 2. FIG. 22 is a schematic diagram showing a configuration of an analysis system according to the second embodiment. According to the second embodiment, one user's PC 3 directly connects to the printer 2 via a USB (Universal Serial Bus) cable, a printer cable, a LAN cable or the like.

The form in which the user's PC 3 and the printer 2 are connected via a USB cable will be described below. The user's PC 3 transmits a job to the printer 2 directly, not through the print server 1, and the printer 2 receives it and performs printing thereof. The user's PC 3 on the other hand transmits a job for point calculation to the print server 1. The print server 1 calculates points by the method in the description of the first embodiment.

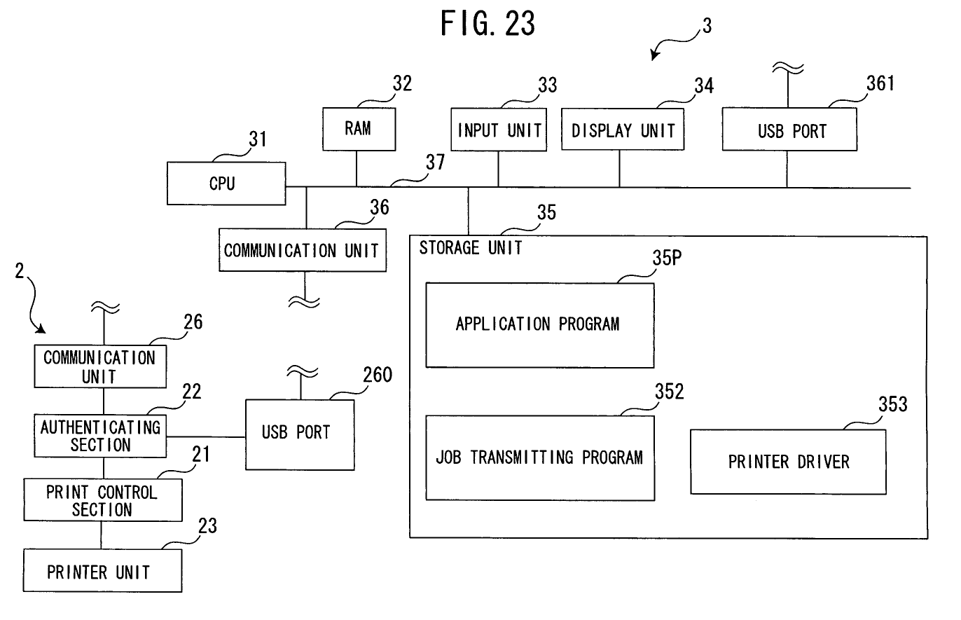

FIG. 23 is a block diagram showing the hardware configurations of the user's PC 3 and printer 2 according to the second embodiment. In addition to the configuration of the first embodiment, the user's PC 3 further includes a USB port 361, and the printer 2 further includes a USB port 260. The USB port 361 of the user's PC 3 and the USB port 260 of the printer 2 are connected via a USB cable. A printer driver 353 and a job transmission program 352 are further installed in the storage unit 35.

A user may create a document with the application program 35P and operate a print button through the input unit 33. Thus, the printer driver 353 starts, and the job is directly transmitted through the USB port 361 to the USB port 260 of the printer 2. The job is output to the authenticating section 22.

The authenticating section 22, which does not receive the signal of print-non-permitting from the print server 1, outputs the job to the print control section 21. The print control section 21 controls the printer unit 23 and performs the printing. In a case where the job is output to the USB port 361, the CPU 31 starts the job transmission program 352 and transmits the job to the print server 1. The print server 1 receives the job and performs the point calculation processing as in the description of the first embodiment.

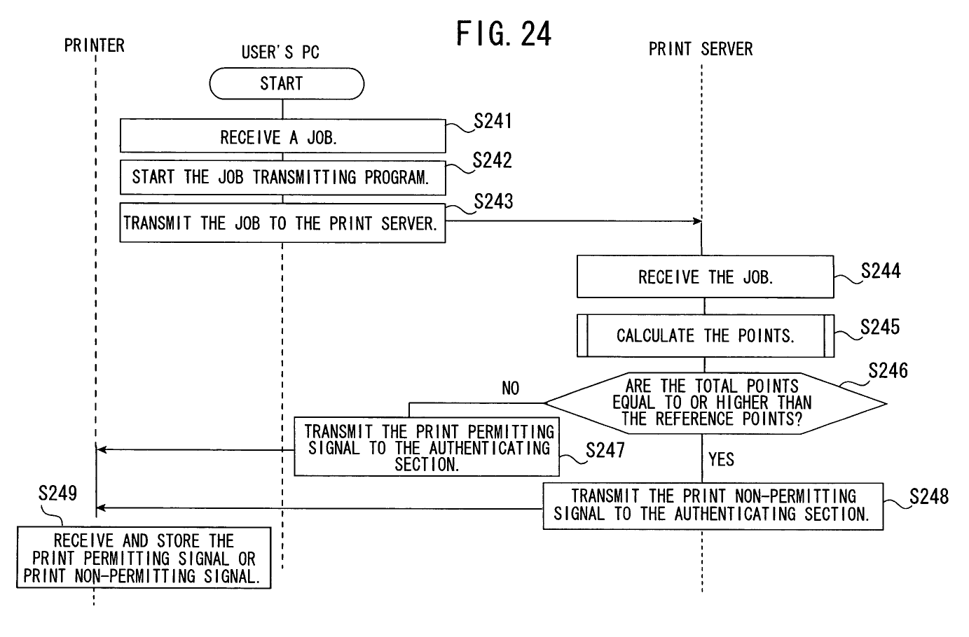

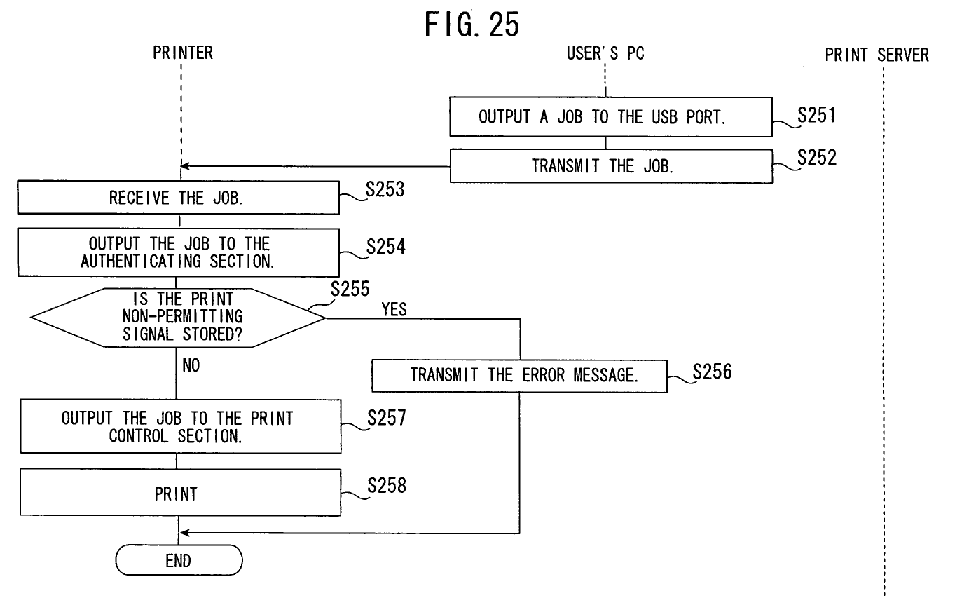

FIGS. 24 and 25 are flowcharts showing a routine of printing processing according to the second embodiment. The CPU 31 of the user's PC 3 receives a job through the input unit 33 (operation S241). The CPU 31 starts the job transmission program 352 (operation S242) and transmits the job to the print server 1 through the communication unit 36 (operation S243). The CPU 11 of the print server 1 receives the job (operation S244). Then, the CPU 11 calculates the points of the job as in the description of the first embodiment (operation S245) and determines whether the total points are equal to or higher than reference points or not (operation S246).

If it is determined that the total points are not equal to or higher than the reference points (NO in operation S246), the CPU 11 transmits a print-permitting signal to the authenticating section 22 of the printer 2 through the communication unit 16 (operation S247) to permit the printing. If it is determined that the total points are equal to or higher than the reference points (YES in operation S246) on the other hand, the CPU 11 transmits a print-non-permitting signal to the authenticating section 22 of the printer 2 through the communication unit 16 (operation S248) to stop the printing. The communication unit 26 of the printer 2 receives the transmitted print-permitting signal or print-non-permitting signal, and the authenticating section 22 receives and stores it in an internal memory, not shown (operation S249).

The CPU 31 of the user's PC 3 outputs the job input through the input unit 33 to the USB port 361 (operation S251), and the job is transmitted to the printer 2 through the USB port 361 (operation S252). The job is received by the USB port 260 of the printer 2 (operation S253). The USB port 260 outputs the job to the authenticating section 22 (operation S254). The authenticating section 22 determines whether a print-non-permitting signal is stored in the internal memory, not shown, or not (operation S255). The authenticating section 22 stores the IP address of the user's PC 3, which is permitted to print, and authenticates the user's PC 3 by comparing the transmitted IP address and pre-stored IP addresses every time a job is received.

If it is determined that the print-non-permitting signal is stored (YES in operation S255), the authenticating section 22 loads an internally stored error message and transmits the loaded error message to the user's PC 3 through the USB port 260 or the communication unit 26 (operation S256). The CPU 31 of the user's PC 3 pop-up displays the error message on the display unit 34. If it is determined that no print-non-permitting signals are stored (NO in operation S255), the authenticating section 22 outputs the job to the print control section 21 (operation S257). The print control section 21 controls the printer unit 22 according to the job and performs printing processing (operation S258).

The second embodiment has the configuration as described above, and the other configurations and operations are similar to those of the first embodiment. Therefore, the same reference characters are given to the corresponding parts, and the detail descriptions thereon will be omitted herein.

### Third Embodiment

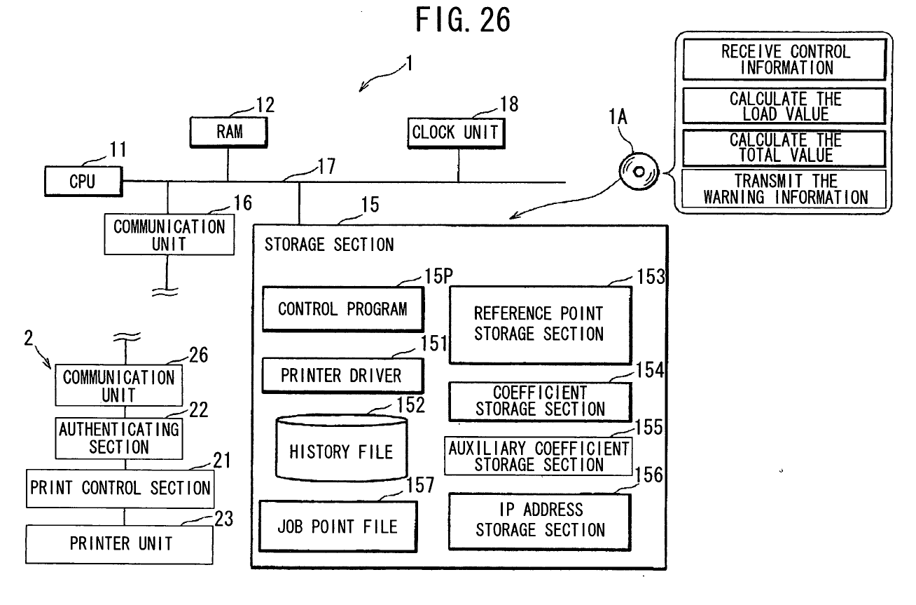

FIG. 26 is a block diagram showing the configurations of the print server 1 and printer 2 according to the third embodiment. A program for operating the print server 1 according to the first and second embodiments may be read from a portable recording medium 1A such as a CD-ROM by a recording medium reader (not shown) and be stored in the storage unit 15 or may be downloaded from another computer (not shown) connecting thereto over a communication network N, as in the third embodiment. The details will be described below.

The print server 1 shown in FIG. 26 downloads a program, which causes to receive control information, calculate a load value, store the total value and transmit warning information, from another computer (not shown) from the portable recording medium 1A or through the communication unit 16 and installs it as the control program 15P of the storage section 15.

Alternatively, the program is installed as an additional application for the printer driver 151. The program is loaded to the RAM 12 to execute. The execution of the program expands the history file 152, job point file 157, reference point storage section 153, coefficient storage section 154 and auxiliary coefficient storage section 155, for example, as in the description of the first and second embodiments to the storage unit 15, and the processing is performed. Thus, the program can function as the print server 1 according to the first or second embodiment as described above.

The third embodiment has the configuration as described above, and the other configurations and operations are the same as those of the first or second embodiment. Therefore, the same reference characters are given to the corresponding parts, and the detail descriptions thereon will be omitted herein.

### Fourth Embodiment

A fourth embodiment of the invention relates to a form in which the machine is applied to storage. The description of this embodiment assumes that the machine is a database (which will be called DB 20), which is a large-capacity storage and that a computer performing point calculation is a DB server 10.

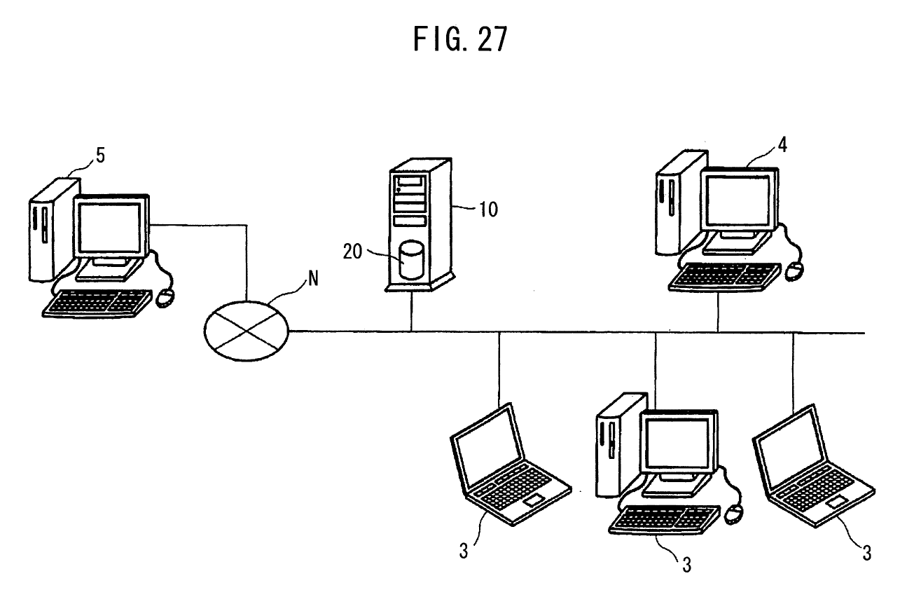

FIG. 27 is a schematic diagram showing a configuration of an analysis system according to the fourth embodiment. The user's PC 3 transmits a job to the DB 20, and the DB server 10 controls the DB 20 according to the transmitted job. The DB server 10 performs point calculation processing, determines whether the total points have reached the reference points or not and transmits warning information to the manager's PC 4 if so.

The job may be writing data to the DB 20. The following description assumes that the amount of job included in the job, which is control information, is the size of the data to write to the DB 20, and the job detail included in the job, which is control information, is encoding processing on the write data to the DB 20. Therefore, the DB server 10 increases the points as the size of the write data increases and decreases the basic point if the encoding processing is not requested and increases the basic point if the encoding processing is requested.

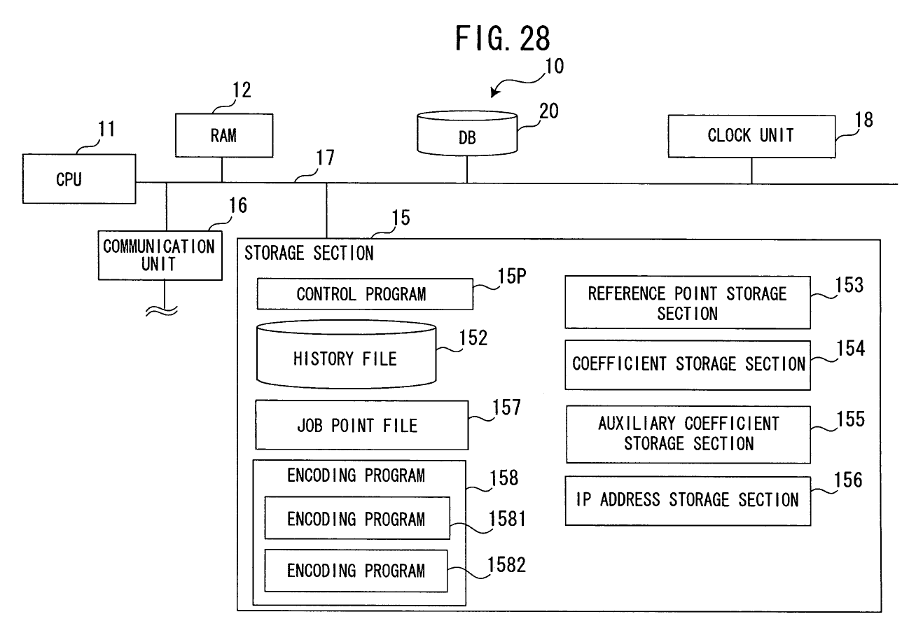

FIG. 28 is a block diagram showing the hardware configuration of the DB server 10 according to the fourth embodiment. The DB server 10 internally includes the large-capacity DB 20. The CPU 11 performs processing of storing or searching required information, for example, by interacting through an access interface according to the format of the database such as SQL (Structured Query Language) in a schema associating with keys of fields of the DB 20.

The storage section 15 stores an encoding program 158 for encoding data received from the user's PC 3. Encoding programs 158 at multiple levels are prepared according to the strengths of encoding. According to this embodiment, for simple description, encoding programs 1582 and 1581 for different two strengths are provided, for example. Here, the following description assumes that the encoding program at Encoding Level 2 for the highest strength is the encoding program 1582 and that the encoding program at Encoding Level 1 for the next high strength is the encoding program 1581. Notably, the encoding method may adopt a common key method, and the strength may be increased or decreased according to the height of the number of bits of the key.

In a case where a command to encode (which will be called encoding command) and an encoding level are received as the job details, the CPU 11 encodes received data according to the encoding level and stores the result in the DB 20. The CPU 11 extracts the data size to be stored in the DB 20 as the amount of job from the job for point calculation. Furthermore, the encoding command and an encoding level are extracted as the job details from the job. Notably, if no encoding commands exist, the CPU 11 stores the received data in the DB 20 without encoding.

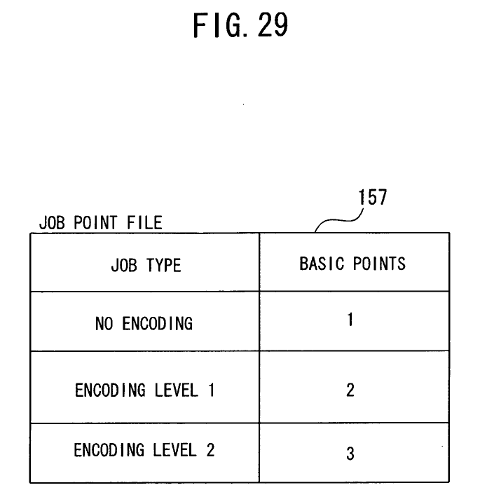

FIG. 29 is an explanatory diagram showing a record layout of the job point file 157 according to the fourth embodiment. The job point file 157 stores a basic point in relation with a job detail. In a case without encoding, the basic point to be stored is 1. In a case with Encoding level 1 with a low strength, the basic point to be stored is 2. In a case with Encoding Level 2 with a high strength, the basic point to be stored is 3.

The coefficient storage section 154 stores a coefficient that increases as the elapsed time from the operation starting date and time of the DB 20 increases. The auxiliary coefficient storage section 155 stores an auxiliary coefficient that varies according to the value of the interval between the received date and time when a job is received and the received date and time when a job is received last time. The auxiliary coefficient storage section 155 may have the same configurations as those of the first embodiment.

The CPU 11 in response to the receipt of a job through the communication unit 16 accepts it and performs point calculation under the control of the control program 15P. As the point, the basic point corresponding to the job detail of no encoding, Encoding Level 1 or Encoding Level 2 from the job point file 157 is loaded from the job point file 157 and is multiplied by the data size. In this case, the number of bytes of the data size may be directly multiplied, but the data size in megabytes, gigabytes or terabytes may be multiplied.

In a case where the amount of data to be stored is 5.5 gigabytes, for example, the number of bytes below one gigabyte may be dropped, and 5 may be multiplied thereby. The CPU 11 as in the description of the first embodiment calculates the points by multiplying the coefficient stored in the coefficient storage section 154 and the auxiliary coefficient stored in the auxiliary coefficient storage section 155 as required.

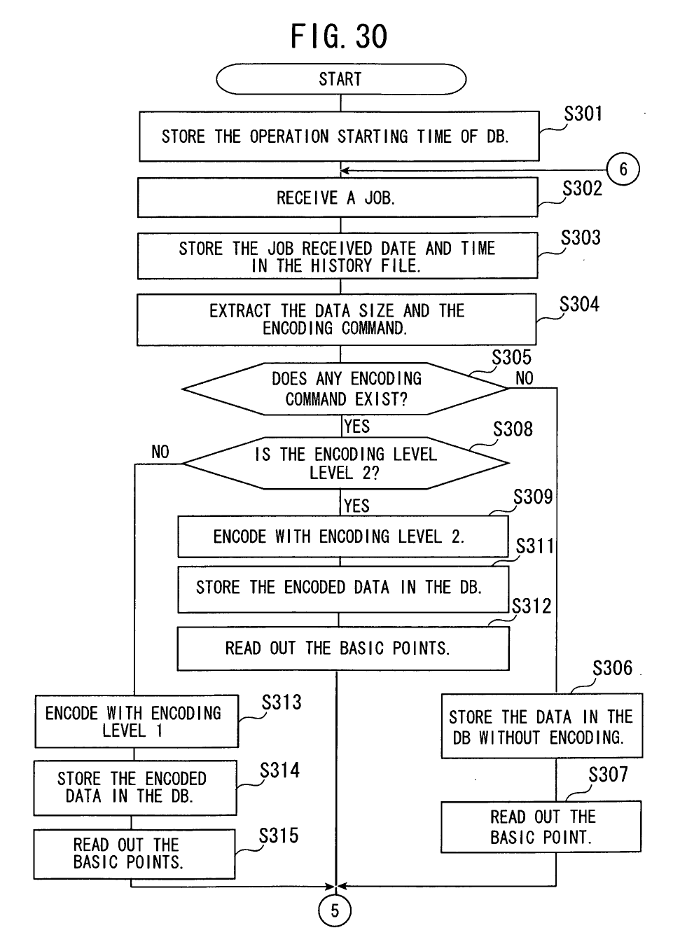

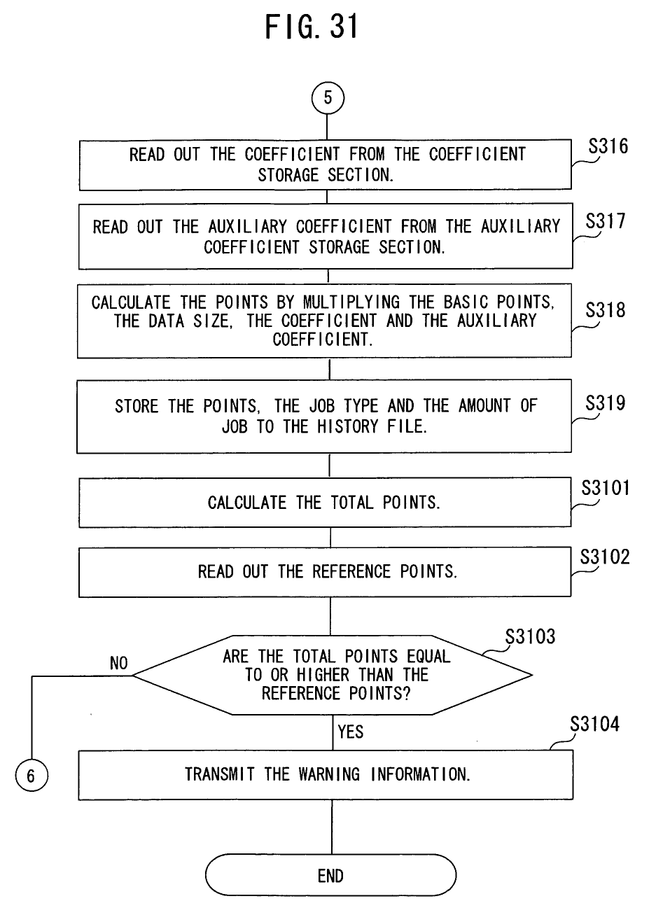

FIGS. 30 and 31 are flowcharts showing a routine of transmitting warning information according to the fourth embodiment. The CPU 11 of the DB server 10 obtains the operation starting time of the DB 20 with reference to the output by the clock unit 18 and stores it in the history file 152 (operation S301). The CPU 11 receives a job transmitted from the user's PC 3 through the communication unit 16 (operation S302). The CPU 11 accepts the received job. The CPU 11 obtains the job received date and time with reference to the output of the clock unit 18 and stores it in the history file 152 (operation S303). The CPU 11 extracts the data size and the encoding command from the received job (operation S304).

The CPU 11 determines whether the job has the encoding command or not (operation S305). If not (NO in operation S305), the PCU 11 stores the data in the DB 20 without encoding (operation S306). Then, the CPU 11 loads the basic point corresponding to no encoding from the job point file 157 (operation S307). If so (YES in operation S305) on the other hand, the CPU 11 determines whether the encoding is Level 2 or not (operation S308). If so (YES in operation S308), the CPU 11 starts the encoding program 1582, performs encoding at Encoding Level 2 (operation S309) and stores the encoded data to the DB 20 (operation S311). The CPU 11 loads the basic point corresponding to Encoding Level 2 from the job point file 157 (operation S312).

If not (NO in operation S308), the CPU 11 starts the encoding program 1581, performs encoding at Encoding Level 1 (operation S313) and stores the encoded data in DB 20 (operation S314). The CPU 11 loads the basic point corresponding to Encoding Level 1 from the job point file 157 (operation S315).

After the processing in operation S315, S312 or S307, the CPU 11 loads the coefficient corresponding to the elapsed time from the operation starting date and time from the coefficient storage section 154 by the processing as in the description of the first embodiment (operation S316). In the same manner, the CPU 11 loads the auxiliary coefficient corresponding to the interval from the auxiliary coefficient storage section 155 by the processing as in the description of the first embodiment (operation S317).

The CPU 11 calculates the points by multiplying the loaded basic point, data size, coefficient and auxiliary coefficient (operation S318). The CPU 11 stores the calculated points, the job details and the amount of job to the history file 152 in relation with the IP address of the user's PC 3 (operation S319). The CPU 11 calculates the total points of the points stored in the history file 152 (operation S3101). The CPU 11 loads the reference points from the reference point storage section 153 (operation S3102). The CPU 11 determines whether the total points calculated in operation S3101 are equal to or higher than the reference points or not (operation S3103).

If not (NO in operation S3103), the CPU 11 determines that the use is permitted within the current contract range and returns the processing to operation S302 again. If so (YES in operation S3103) on the other hand, the CPU 11 creates the warning information as in the description of the first embodiment and transmits it to the manager's PC 4 through the communication unit 16 to prompt the contract update (operation S3104). Apparently, the program causing to perform the software processing as described above may be installed through a CD-ROM or downloaded to the storage unit 15 as in the description of the third embodiment.

The fourth embodiment has the configuration above, and the other configurations and operations are similar to those of the first to third embodiments. Therefore, the same reference characters are given to the corresponding parts, and the detail descriptions will be omitted herein.

According to the invention, the load value of the processing on a machine is calculated by the calculating operation, and the total values of the load values of the machine is sequentially stored in the storage unit, based on the received control information. Then, if the total value reaches the reference value stored in the storage unit, warning information is transmitted to the information processing apparatus. Thus, the configuration of the machine can be minimized, and charging the fee based on the maintenance contract based on the usage pattern can be implemented. Since warning information is transmitted when the total value reaches the reference value, the contract update can be implemented continuously.

According to the invention, when the total value reaches the reference value, the message on the fact that the total value has reached the reference value and the address for accessing a server computer connected over a communication network are loaded. Then, warning information including the loaded message and address are transmitted to the information processing apparatus. Thus, a user can recognize the necessity of the contract update and can easily access the server computer for the contract update.

According to the invention, the load value corresponding to the extracted control detail is loaded, and the load value is derived by multiplying the loaded load value by the value regarding the amount of control. Thus, proper fee charging can be implemented, keeping the simple configurations of the machine.

According to the invention, the coefficient corresponding to the elapsed time is loaded, and the load value is calculated by multiplying the loaded coefficient, load value and the value regarding the amount of control. Thus, the invention provides excellent effects including the effect that the usage pattern can be analyzed in consideration of the load on a machine based on a time element.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An analysis method that analyzes the usage pattern of a machine operating in accordance with control information transmitted from an information processing apparatus by using an analysis apparatus, the method comprising:
receiving the control information transmitted from the information processing apparatus connected thereto over a communication network;
calculating a load value of processing on the machine based on the received control information;
storing the total value of the calculated load values of the machine, into a storage section; and
transmitting warning information to the information processing apparatus if the stored total value reaches a reference value stored in the storage section.

2. An analysis system that analyzes the usage pattern of a machine operating in accordance with control information transmitted from an information processing apparatus by using an analysis apparatus, the system comprising:
the information processing apparatus; and
the analysis apparatus,
the information processing apparatus further comprising:
a first transmitting part transmitting control information for controlling the machine to the analysis apparatus,
the analysis apparatus further comprising:
a receiving part receiving the control information transmitted from the information processing apparatus;
an output part outputting the control information received by the receiving part to the machine;
a calculating part calculating a load value of the processing on the machine based on the control information received by the receiving part;
a storage part storing a total value of the load values of the machine, which are calculated by the calculating part, into a storage section; and
a second transmitting part transmitting warning information to the information processing apparatus if the total value stored by the storage part reaches the reference value stored in the storage section.

3. An analysis apparatus that analyzes the usage pattern of a machine operating in accordance with control information transmitted from an information processing apparatus, the apparatus comprising:
a receiving part receiving the control information transmitted from an information processing apparatus connected thereto over a communication network;
an output part outputting the control information received by the receiving part to the machine;
a calculating part calculating a load value of the processing on the machine based on the control information received by the receiving part;
a storage part storing a total value of the load values of the machine, which are calculated by the calculating part, into a storage section; and
a transmitting part transmitting warning information to the information processing apparatus if the total value stored by the storage part reaches the reference value stored in the storage section.

4. A computer-readable storage medium storing a program for analyzing the usage pattern of a machine operating in accordance with control information transmitted from an information processing apparatus by using an analysis apparatus having a control section, the program causing a computer to function with:
a receiving operation of receiving the control information transmitted from the information processing apparatus;
a calculating operation of calculating a load value of processing on the machine based on the control information received by the receiving operation by the control section;
a storing operation of storing the total value of load values of the machine, which are calculated by the calculating operation, into a storage section; and
a transmitting operation of transmitting warning information to the information processing apparatus by the control section if the total value stored by the storing operation reaches a reference value stored in the storage section.

5. The computer-readable storage medium according to claim 4,
further comprising the operations of:
a loading operation of loading a message on the fact that the total value stored by the storing operation has reached the reference value stored in the storage section if the total value has reached the reference value stored in the storage section and an address for accessing a server computer connected over a communication network by the control section;
wherein the transmitting operation transmitting warning information containing the message and address loaded by the operation to the information processing apparatus by the control section.

6. The computer-readable storage medium according to claim 4, wherein the calculating operation calculates, as the load value, the value regarding the amount of control over the machine within the control information received by the receiving operation by the control section.

7. The computer-readable storage medium according to claim 4, the calculating operation further comprising:
an extracting operation of extracting a control detail of and the amount of control over the machine within the control information received by the receiving operation by the control section;
an operation of loading the load value corresponding to the control detail extracted by the extracting operation from the storage section storing the load values of the processing on the machine in accordance with the control detail by the control section; and
an operation of multiplying the load value loaded by the operation by the value regarding the amount of control by the control section.

8. The computer-readable storage medium according to claim 4, the calculating operation further comprising:
an extracting operation of extracting a control detail of and the amount of control over the machine within the control information received by the receiving operation by the control section;
a loading operation of loading the load value corresponding to the control detail extracted by the extracting operation from the storage section storing the load values of the processing over the machine in accordance with the control detail by the control section;
an obtaining operation of obtaining date-and-time information from a clock unit outputting date-and-time information by the control section;
an operation of loading a coefficient corresponding to the elapsed time based on the date-and-time information obtained by obtaining operation from a coefficient storage section storing a coefficient the value of which varies based on the length of the elapsed time from the time when the machine is started by the control section; and
an operation of multiplying the coefficient loaded by the operation, the load value loaded by the loading operation and the value regarding the amount of control by the control section.

9. The computer-readable storage medium according to claim 4, the calculating operation further comprising:
an extracting operation of extracting a control detail of and the amount of control over the machine within the control information received by the receiving operation by the control section;
a loading operation of loading the load value corresponding to the control detail extracted by the extracting operation from the storage section storing the load values of the processing on the machine in accordance with the control detail by the control section;
an obtaining operation of obtaining date-and-time information when the control information is received by the receiving operation from a clock unit outputting date-and-time information by the control section;
a history storing operation of storing the date-and-time information obtained by the obtaining operation into the storage section as a history;
a time interval calculating operation of calculating a time interval from the time when the machine is operated previously based on the date-and-time information stored in the storage section by the operation by the control section;
an operation of loading an auxiliary coefficient based on the time interval calculated by the time interval calculating operation from an auxiliary coefficient storage section storing an auxiliary coefficient the value of which varies according to the length of the time interval by the control section; and
an operation of multiplying the auxiliary coefficient loaded by the operation, the load value loaded by the loading operation and the value regarding the amount of control by the control section.

10. The computer-readable storage medium according to claim 4, the calculating operation further comprising:
an extracting operation of extracting a control detail of and the amount of control over the machine within the control information received by the receiving operation by the control section;
a loading operation of loading the load value corresponding to the control detail extracted by the extracting operation from the storage section storing the load values of the processing on the machine in accordance with the control detail by the control section;
an obtaining operation of obtaining date-and-time information when the control information is received by the receiving operation from a clock unit outputting date-and-time information by the control section;
a history storing operation of storing the date-and-time information obtained by the obtaining operation into the storage section as a history;
a time interval calculating operation of calculating a time interval from the time when the machine is operated previously based on the date-and-time information stored in the storage section by the operation by the control section;
a coefficient loading operation of loading the coefficient corresponding to the elapsed time based on the date-and-time information obtained by the obtaining operation from a coefficient storage section storing a coefficient the value of which varies according to the length of the elapsed time from the time when the machine is started by the control section;
an auxiliary coefficient loading operation of loading an auxiliary coefficient based on the time interval calculated by the time interval calculating operation from an auxiliary coefficient storage section storing an auxiliary coefficient the value of which varies according to the length of the time interval by the control section; and
an operation of multiplying the coefficient loaded by the coefficient loading operation, the auxiliary coefficient loaded by the auxiliary coefficient loading operation, the load value loaded by the loading operation and the value regarding the amount of control by the control of the control section.
